(19) United States
(12) Patent Application Publication
(10) Pub. No.: US 2014/0195255 A1
(43) Pub. Date: Jul. 10, 2014

(54) System And Method For Assessment Of Patient Health Using Patient Generated Data

(71) Applicants: ROBERT BOSCH HEALTHCARE SYSTEMS INC., Palo Alto, CA (US); ROBERT BOSCH GMBH, Stuttgart (DE)

(72) Inventors: Rajib Ghosh, Sunnyvale, CA (US); Henning Hayn, Stuttgart (DE)

(73) Assignees: ROBERT BOSCH GMBH, Stuttgart (DE); ROBERT BOSCH HEALTHCARE SYSTEMS INC., Palo Alto, CA (US)

(21) Appl. No.: 13/736,732

(22) Filed: Jan. 8, 2013

(51) Int. Cl. G06F 19/00; G06Q 50/22

(52) U.S. Cl. CPC G06F 19/3418; G06Q 50/22
USPC 705/2

(57) ABSTRACT

A method for evaluating a patient in telehealth treatment includes receiving non-medical data corresponding to a patient from a social network service through a data network, identifying a health characteristic of the patient in the non-medical data, generating a message including health advice associated with the identified health characteristic of the patient, and sending the message to an electronic device associated with the patient through the data network.

### TECHNICAL FIELD

This patent relates generally to the fields of medical information and patient management, and, more particularly, to methods and systems for assessing patients who are undergoing telehealth treatment.

### BACKGROUND

The fields of telehealth and home healthcare have experienced strong growth in recent years. In a telehealth system, a patient is geographically removed from the presence of a doctor or other healthcare provider. For example, the patient could be at home instead of being present at a healthcare facility. Telehealth devices enable the healthcare provider to monitor the health status of a patient and potentially diagnose and treat some medical problems without the need for the patient to travel to the healthcare facility. The use of telehealth systems has the potential to reduce the cost of healthcare, and to improve the quality of healthcare through increased patient monitoring.

As described above, a patient undergoing telehealth treatment is typically well enough to be treated outside of a hospital even though the patient has one or more diagnosed medical conditions. In many cases, the patient is ambulatory and is well enough to conduct daily activities including, but not limited to, working, exercising, traveling, eating in restaurants, and engaging in numerous other activities outside of the home. Ambulatory patients present challenges to effective treatment in a telehealth system. For example, patients often leave monitoring equipment and telehealth devices at home and engage in activities outside the home that are difficult to document in the telehealth system. Some telehealth systems present surveys and questionnaires for the patients, but the questionnaires are typically in the form of multiple choice questions and do not capture the full breadth of activity for the patient. While telehealth systems often present the patient with medical advice based on the condition and activities of the patient, the telehealth system cannot generate effective medical advice without an effective assessment of the activities and state of the patient. Additionally, the mental state of the patient is also an important factor in the efficacy of many telehealth treatment programs. While telehealth devices present questions to the patient regarding happiness and mood, the true mental state of the patient can be difficult to assess from a standardized set of questions. Thus, improvements to telehealth systems that enable assessment and telehealth treatment of the patient while the patient engages in different activities at different locations would be beneficial.

### SUMMARY

In one embodiment, a method for assessing a patient who is undergoing telehealth treatment has been developed. The method includes receiving with a processor communicatively connected to a data network non-medical data corresponding to a patient from a social network service that is connected to the data network, identifying with the processor a health characteristic of the patient in the non-medical data received from the social network service, generating with the processor a message including health advice associated with the identified health characteristic of the patient, and sending with the processor the message to an electronic device associated with the patient through the data network.

In another embodiment, a telehealth system that is configured to assess a patient has been developed. The system includes a memory configured to store account credentials for an account on a social network service that is associated with another account used by the patient on the social network service, medical record data corresponding to the patient including data corresponding to at least one diagnosed medical condition for the patient, and address information identifying at least one of an account associated with the patient in the social network and an address identifier for an electronic device associated with the patient. The system also includes a processor operatively connected to the memory and to a data network and configured to access the social network service through the data network with the account credentials stored in the memory to receive non-medical data corresponding to the account associated with the patient from the social network service, identify a health characteristic of the patient in the non-medical data received from the social network service, retrieve one of the plurality of health advice messages from the memory, generate a message that includes health advice retrieved from the associated with the identified health characteristic of the patient, and send the message to an electronic device corresponding to the address information in the memory through the data network.

### BRIEF DESCRIPTION OF THE DRAWINGS

FIG. 1 is a schematic diagram of a healthcare system that is configured to identify a health characteristic of a patient from non-medical data that the patient submits to a social network service and for sending a health advice message corresponding to the health characteristic to an electronic device that is associated with the patient.

FIG. 2 is a block diagram of a process for identifying the health characteristic of a patient in a telehealth system from information posted to a social network service and for sending a health advice message corresponding to the health characteristic to an electronic device that is associated with the patient.

FIG. 3 is a block diagram of a process for identifying an activity in which a telehealth patient participates from data that the patient submits to a social network service and for sending a health advice message corresponding to the activity to an electronic device that is associated with the patient.

FIG. 4 is a block diagram of a process for identifying a restaurant in which a telehealth patient dines from information posted on a social network service and for sending a health advice message for dining recommendations to an electronic device that is associated with the patient.

FIG. 5 is a block diagram of a process for identifying a location of a patient from data posted to a social network service and for and for sending a health advice message including recommendations for healthcare or recreational facilities to an electronic device that is associated with the patient when the patient is away from home.

FIG. 6 is a block diagram of a process for identifying a mental state of a patient from data posted to a social network service and for sending a health advice message corresponding to the mental state of the patient to an electronic device that is associated with the patient.

FIG. 7 is a schematic diagram of functional units that are implemented by a processor in a telehealth system for identification of an activity in which a patient participates and a health characteristic associated with the activity.

FIG. 8 is a schematic diagram of functional units that are implemented by a processor in a telehealth system for identification of a location of a patient and a health characteristic associated with the patient.

FIG. 9 is a schematic diagram of functional units that are implemented by a processor in a telehealth system for identification of a mental state of the patient.

### DETAILED DESCRIPTION

For the purposes of promoting an understanding of the principles of the embodiments described herein, reference is now be made to the drawings and descriptions in the following written specification. No limitation to the scope of the subject matter is intended by the references. This patent also includes any alterations and modifications to the illustrated embodiments and includes further applications of the principles of the described embodiments as would normally occur to one skilled in the art to which this document pertains.

The term “telehealth” as used herein refers to a form of medicine in which a patient and healthcare provider electronically communicate with one other to enable the patient, who is not located in the healthcare provider's facility, to receive medical treatment from the healthcare provider. The term “telehealth device” as used herein refers to any device that is configured to electronically transmit and/or receive data pertaining to a telehealth treatment received by a patient from a healthcare provider practicing telehealth on the patient. A telehealth device is one example of a more general category of medical devices, which include any device having diagnostic and/or therapeutic uses, such as respirators, pace makers, blood sugar testing devices, inhalators, heart monitors, and the like. While the specific embodiments described herein are directed to telehealth devices, the systems and methods described herein are also suitable for use with a wide variety of medical devices.

The term “medical data” as used herein refers to any data that are specifically elicited from a patient for the purpose of providing healthcare to the patient. The term “non-medical data” refers to a wide range of data that the patient generates during daily activities that are not produced expressly for the purpose of healthcare. For example, as described below many patients use one or more social network services. The patients post multiple types of data to the social network services for a wide range of purposes, including business, travel, recreation, and social activities. Even though non-medical data are not generated for the purpose of healthcare, the telehealth system described herein processes non-medical data to assess the state of health of the patient who generates the non-medical data. As used herein, the term “health characteristic” refers to any aspect of the condition or activities of the patient that can affect the health of the patient. Examples of health characteristics include, but are not limited to, the location of the patient, activities that the patient undertakes, and the mental state of the patient. As described below, a telehealth system identifies one or more health characteristics for a patient using non-medical information that the patient generates and provides to social network services.

As used herein, the term “emoticon” refers to a short string of text characters that is recognized as corresponding to an emotional state or mood. The text used for an emoticon is typically recognizable as a human face making an expression such as, for example, smiling, frowning, winking, laughing, crying, showing anger, showing fear, showing surprise, etc. Some computing devices including personal computers and portable electronic devices, such as mobile phones, which identify text strings that correspond to emoticons and display a graphical icon corresponding to the emoticon instead of the text characters that form the emoticon.

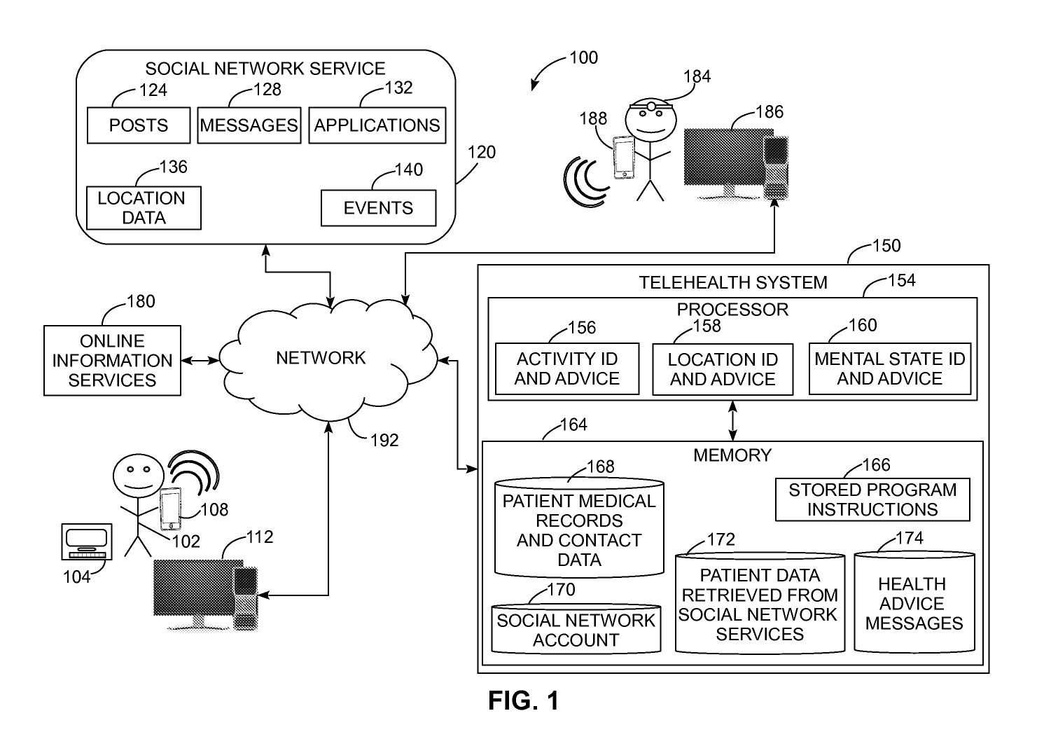

FIG. 1 depicts a system 100 including one or more electronic devices that are used by a patient 102, a social network service 120, a telehealth system 150, electronic devices that are associated with a healthcare professional 184 who treats the patient 182, and one or more online information services 180. During operation, the patient 102 generates multiple types of non-medical information that are stored in the social network service 120 and made available to users of the social network service 120. The telehealth system 150 retrieves some or all of the non-medical information that corresponds to the patient 102 from the social network service 120. The telehealth system 150 then identifies one or more health characteristics pertaining to the patient 102 and sends health advice messages to the patient 102, and optionally alerts the healthcare professional 184 to certain health characteristics that may require attention from the healthcare professional 184. For some types of health characteristics, the telehealth system 150 retrieves additional data from one or more online information services 180 to generate the health advice messages. Additional details and descriptions of the method of operation of the system 100 are presented below.

In the system 100, the patient 102 uses one or more electronic devices, including a telehealth terminal 104, a mobile electronic device, such as a smartphone 108, and a personal computer (PC) 112, for communicating medical data through the data network 192 as part of telehealth treatment and for communicating non-medical data. The data network 192 includes one or more local area networks (LANs) and wide area networks (WANs) that enable the patient 102 to use one or more electronic devices for communication with the social network service 120, telehealth system 150, online information services 180, and the healthcare professional 184. In one embodiment, the network 192 is the Internet and the patient 102 accesses the Internet through a wired or wireless Internet connection provided by an Internet service provider (ISP).

In the illustrative embodiment of the system 100, the patient 102 uses a telehealth terminal device 104 to communicate with the telehealth system 150 and the healthcare professional 184 through a data network 192. In one operating mode, the telehealth terminal 104 is used for the communication of medical data expressly for the purposes of providing telehealth treatment to the patient 104. The telehealth terminal 104 receives health advice messages from the telehealth system 150 and the healthcare professional 184. As described below, the telehealth system 150 identifies health characteristics for the patient 102 from non-medical information that is posted to the social network 120. In one configuration, the telehealth system 150 generates health advice messages for the patient 102 that correspond to the identified health characteristics and sends the messages to the telehealth terminal 104. While FIG. 1 depicts a telehealth terminal 104 that uses a dedicated hardware device, in another embodiment the functionality of the telehealth terminal 104 is provided through a software application that is executed using other electronic devices that are associated with the patient 102, including one or both of the smartphone 108 and PC 112.

The patient 102 uses the smartphone 108, and personal computer (PC) 112 to communicate with one or more social network services, such as the social network service 120 that is depicted in FIG. 1. The patient 102 registers an account with the social network service 120, and the patient 102 submits information, including text, audio, video, and photographs to the account with the social network service 120. In some submissions, the patient 102 provides information about his or her status and activities, while other submissions include comments about acquaintances of the patient 102 who use the social network service 120. Other forms of posted information include invitations to events such as meetings or social gatherings. The social network service 120 stores the posted information in one or more databases and enables users of other accounts to view some or all of the posted content. In the embodiment of FIG. 1, the patient 102 uses a web browser to access the social network 120 using the PC 112, and either a web browser or a dedicated software application (colloquially referred to as an “app”) using the smartphone 108. In one configuration, a portion of the content that the user 102 submits to the social network is available, while other portions of the content are only available to other user accounts that the patient 102 selects to grant access to the content.

The smartphone 108 and some PC device embodiments include additional sensors that optionally provide additional information about the patient 102 to the social network service 120. For example, the smartphone 108 includes a global positioning system (GPS) device or another device that identifies the geographic location of the patient 102. In one operating mode, the smartphone 108 sends the location information to the social network service 120 to enable the patient 102 to reveal his or her location to friends. In another embodiment, the smartphone 108 includes a camera that takes pictures and video. The smartphone 108 embeds location information and date metadata in the photographs and video using, for example, the Exchangeable Image File (EXIF) format. Other users and software applications that access the photographs and video through the social network 120 and can identify the location and date of production for the photograph or video from the location metadata.

In one embodiment, the social network service 120 is a commercial service that is not directly controlled by the patient 102, healthcare professionals 184, or the telehealth system 150. In one embodiment, the social network services 120 stores data corresponding to posts 124, messages 128, data corresponding to one or more applications 132, location data 136, and data corresponding to one or more events 140. While FIG. 1 depicts a single social network service 120 for illustrative purposes, many patients use multiple social network services and the healthcare system 100 and telehealth system 150 are configured to access data corresponding to the patient 102 from multiple social network services.

In the social network service 120, the posts 124 include any data, including text, pictures, audio, and video, that the patient 102 submits to the social network service 120 for display to other users of the social network 120. The messages 128 include communications that are directed to one other user or a group of users of the social network service 120. The applications 132 include services such as reviews, games, and other applications where the patient 102 participates in an online activity. In some instances, information about the application is made public. For example, when the patient 102 uses a music, movie, or restaurant review application, the social network service 120 publishes results of reviews, including the likes and dislikes of the patient 102, for view by other users of the social network service 120. In some embodiments, the patient 102 updates his or her location 136 with the social network service 120. In one embodiment, the patient 102 updates the location information manually, while in another embodiment an electronic device, such as the smartphone 108, identifies the location of the patient 102 and updates the social network service 120 at regular intervals. The location information can include geographical coordinates, such as latitude and longitude coordinates, but can also include information, such as a store, in which the patient 102 is shopping or a restaurant where the patient 102 is eating a meal. The events data 140 include gatherings, such as meetings or social gatherings, which the patient 102 and other users of the social network service 120 are invited to attend. The data for the events 140 typically include a description of the event, a time and place for the event, and RSVP information for the invited users who plan to attend or not attend the event. The events 140 optionally include comments or additional information posted by users who are invited to the event.

The telehealth system 150 includes a processor 154 and a memory 164 that are configured to communicate with the patient 102 through one or more of the electronic devices 104-112, the social network 120, and a healthcare professional 184 through the data network 192. The telehealth system 150 receives non-medical information pertaining to the patient 102 from the social network service 120, identifies health characteristics for the patient 102 from the non-medical data, and sends health advice messages to one or more of the electronic devices 104-112 associated with the patient 102 based on the identified health characteristics. The telehealth system 150 is also configured to store data for review by healthcare professionals, such as the healthcare professional 184 depicted in FIG. 1. In one embodiment, the telehealth system 150 provides a remote interface, such as a web server, that enables the healthcare professional 184 to review the patient medical records 168 data using a PC 186 or a mobile electronic device such as the smartphone 188 depicted in FIG. 1. The healthcare professional 184 also uses the remote interface to review and update the health advice messages 174 that are stored in the memory 164 as part of the telehealth treatment for the patient 102. The telehealth system 150 updates the patient medical records data 168 with the identified health characteristics of the patient 102, and the healthcare professional 184 can review the records to assess the health of the patient 102 and identify if the patient 102 is following medical advice from doctors or other healthcare providers.

In one embodiment of the telehealth system 150, the processor 154 includes multiple central processing unit (CPU) and optionally graphical processing unit (GPU) components that are arranged in a cluster of multiple computing devices for providing telehealth treatment services to a large number of patients, including the patient 102 who is depicted in FIG. 1. The processor 154 is communicatively coupled to the memory 164 for loading and storing data during operation of the telehealth system 150. In the embodiment of FIG. 1, the processor 154 is configured to identify and generate health advice messages for the patient 102 based on identified patient activities 156, identified patient locations 158, and identified patient mental states 160. The processor 154 executes the stored program instructions 166 in the memory 164 to identify the health characteristics and generate the health advice messages.

The memory 164 includes non-volatile data storage devices, such as magnetic drives, solid state storage devices, optical storage devices, and the like, for long-term storage of stored program instructions 166, patient medical records 168, social network account data 170, patient data 172 that are retrieved from social network services, and health advice messages 174. The memory 166 stores the data using, for example, files stored using file systems, relational databases, object oriented databases, hierarchical databases, key-value stores, comma separated value (CSV) files, and any other arrangement of data that enables the processor 154 to store and retrieve data from the memory 164. The memory 164 also includes volatile memory devices, such as static and dynamic random access memory (RAM), which the processor 154 uses during the processing described below. The processor 154 reads stored program instructions 166 from the memory 164 to perform telehealth services including the identification of health characteristics for the patient 102 using data received from the social network service 120 and generation of health advice messages for the patient 102.

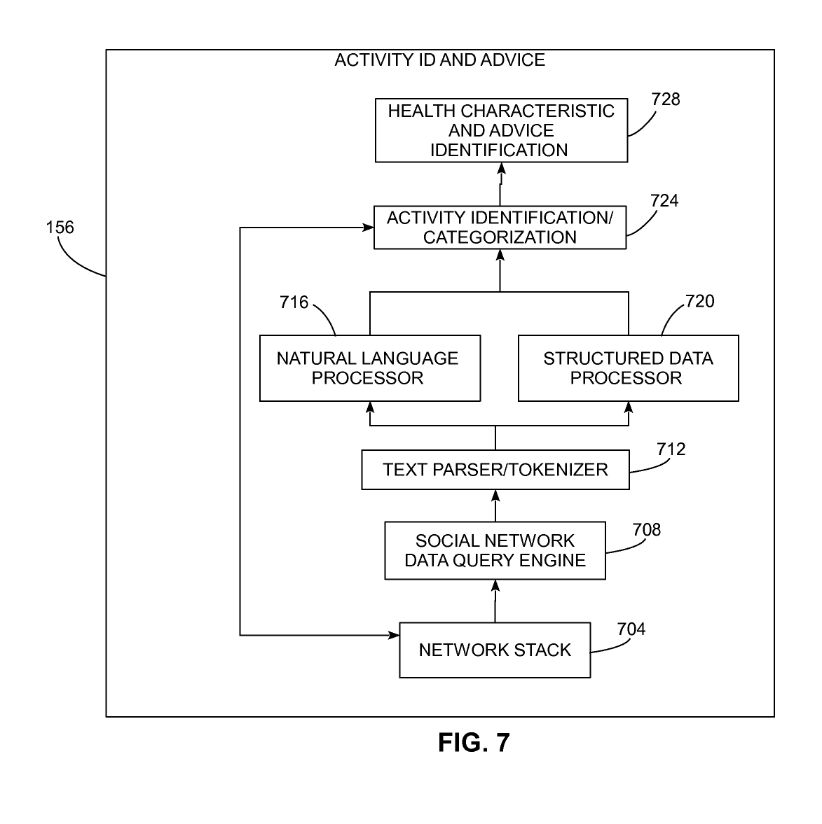

FIG. 7 depicts the patient activity and health characteristic identification module 156 in the telehealth system 150. FIG. 7 includes functional elements that are embodied as a combination of digital processing hardware and software components in the telehealth system 150. The module 156 includes a network stack 704, social network data query engine 708, text parser/tokenizer 712, natural language processor 716, structured data processor 720, activity identification module 724, activity categorization module 728, and health characteristic and advice identification module 732. The network stack 704 provides hardware and software components that enable the telehealth system 150 to send and receive data from other computing devices through the network 192. In one embodiment the network stack 704 is implemented using the Transmission Control Protocol (TCP) or Uniform Datagram Protocol (UDP) over a version of the Internet Protocol (IP) to enable the telehealth system 150 to communicate with other networked computing devices, including the social network service 120.

The social network data query engine 708 is configured to retrieve data corresponding to the patient 102 from the social network service 120. In one embodiment, the social network data engine 708 performs a login process using stored account credentials 170 for the account corresponding to telehealth system 150. Many social network services are accessed through a web browser, and the social network data query engine 708 includes a web browser engine. The social network data query engine 708 includes a plurality of query templates, including pre-formatted URLs and web-service queries that use, for example, SOAP and XML-RPC services that the social network 120 offers through the network 192. The social network data query engine 708 performs automated retrieval for any of the posts 124, messages 128, application data 132, location data 136, and event data 140 that correspond to the patient 102. Some of the data, such as posts 124 and messages 128, are unstructured text, while other forms of data, such as event data 140 and location data 136, are often stored in a predetermined data format, such as a format that is defined by an XML schema or document type descriptor.

In the module 156, the text parser/tokenizer 712 processes the text data that are retrieved from the social network data query engine 708. The text parser/tokenizer 712 processes the text to extract words and phrases from different documents that are retrieved from the social network service 120. For example, as described above, many social network services provide information using a web server. Some of the data corresponding to the patient 102 are retrieved in hypertext markup language (HTML) format. The text parser/tokenizer removes structured tags that are associated with the HTML and further identifies words, phrases, sentences, and paragraphs that are submitted by human users of the social network 120, including the patient 102. The text parser/tokenizer 712 sends to the natural language processor 716 unstructured text that are extracted from the social media service data. The text parser/tokenizer 712 is also configured to identify structured data, such as data that are stored in XML files. For structured data files, the text parser/tokenizer 712 is configured to generate an appropriate data structure, such as a Document Object Model (DOM) data structure, which is then processed by the structured data processor 720.

The natural language processor 716 performs analysis of unstructured text, which typically includes text that is submitted by a human user of the social network service 120. The natural language processor 716 uses natural language processing techniques, which are known to the art, and that include, but are not limited to, Bayesian classification, hidden Markov models, and conditional random fields (CRFs) to identify predetermined features in unstructured text. While human language is complex and often ambiguous, the natural language processor 716 is configured to recognize a relatively small vocabulary of terms and semantics to extract meaningful information from text in an automated manner for specific purposes. For example, in the module 156, the natural language processor 716 is configured to identify words that correspond to various activities that the patient 102 performs. In one embodiment, the natural language processor 716 receives unstructured text from event data 140 that are retrieved from the network. Since an event typically involves some type of activity, the natural language processor 716 has a greater probability of identifying the event in the context of an event invitation.

While HTML files include a series of tags that are used to format data for display using a web browser or other appropriate software, the HTML files typically do not provide semantic structure to the text. For example, a post written by a human user of the social network includes unstructured text that the user submits, and the social network formats the text using HTML to present the text in a visually appealing manner to human users who view the text using a web browser. Structured data such as XML, however, is formatted with predetermined data structures that are intended for analysis in an automated manner. For example, in one embodiment, the social network service publishes events using a predetermined XML format that includes data fields corresponding to the name, location, and date of an event, with additional structured data listing the names of users who are invited to the event. The structured data processor 720 in the telehealth system 150 is configured to recognize the predetermined structure of the XML documents that are retrieved from the social network 120 and to extract relevant pieces of information in an automated manner.

In the module 156, both the natural language processor 716 and the structured data processor 720 extract information corresponding to an event from the data that are received from the text parser/tokenizer 712. An activity identification module 724 then identifies the activity and one or more predetermined attributes about the activity. In one embodiment, the activity identification module 724 consults an ontology that includes a broad range of identifiers for activities and predetermined attributes associated with each activity that can affect the health of the patient 102. Thus, while the term “kayaking” in isolation has no meaning to a computer system, the activity identification and categorization system retrieves attributes about kayaking from predetermined knowledge bases that are compiled by both human and automated sources to provide attributes about kayaking that correspond to health characteristics for humans, including the patient 102.

For example, the activity identification module 724 analyzes both the results from the natural language processor 716 and structured data processor 720 to identify that the patient 102 has been invited to an event for “kayaking”. If the patient 102 accepts the invitation to the event, the structured data processor 720 identifies that the patient 102 has accepted the invitation. The activity identification module 724 categorizes the identified “kayaking” activity using the ontology to retrieve a plurality of attributes about kayaking. In particular, the telehealth system 150 categorizes activities based on attributes that can affect the health of patients. For example, the ontology includes attributes that describe kayaking as being physically strenuous, and that kayaking is an activity that typically occurs outdoors on water. Some ontologies include additional information including statistical risks for different injuries and emergencies that are associated with the activity. In one embodiment, the ontology is stored in the memory 164 in the telehealth system 150, in another embodiment the ontology is provided as an online data service 180, and the activity identification and categorization module 724 accesses the online ontology using the network stack 704.

In the module 156, the health characteristic and advice identification module 728 uses the identified attributes for the activity from the activity identification and categorization module 724 to identify health characteristics in the patient 102 that are affected by the activity, and to generate health advice messages that are pertinent to the activity and to the diagnosed medical conditions for the patient 102. For example, each medical condition that is diagnosed for the patient 102 includes predetermined aggravating and mitigating factors. In one embodiment, the patient medical record data 168 includes the aggravating and mitigating factors. In some embodiments, the healthcare professional 184 inserts aggravating and mitigating factors for the patient 102 into the medical record data 168 based on experiences with the patient 102. The health characteristic and advice module 728 maps the identified attributes of the activity to the aggravating and mitigating factors that are associated with the patient 102. For example, if the patient 102 has asthma, then aggravating factors for an asthma attack may include outdoor activities with a high level of exertion. Since the kayaking activity includes attributes corresponding to both an outdoor and a high-exertion activity, the health characteristic and advice module 728 identifies that the diagnosed asthma condition is a health characteristic of the patient 102 that is affected by the activity. The health characteristic and advice module 728 then identifies a health advice message for the patient 102 that corresponds to the asthma condition. For example, health characteristic and advice module 728 retrieves a health advice message 174 from the memory 164 that advises the patient 102 to bring his or her inhaler along when participating in the activity.

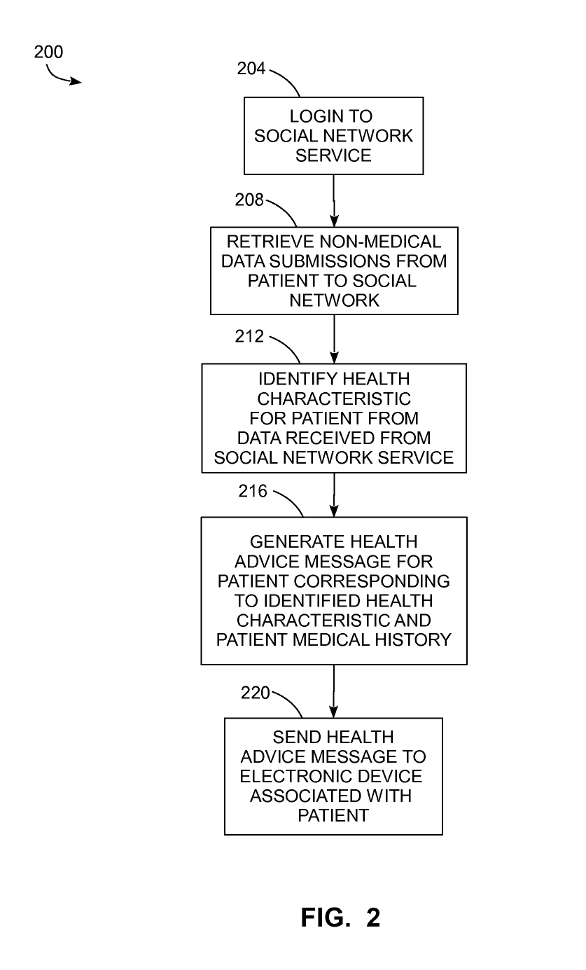

FIG. 2 depicts a process 200 for identifying a health characteristic of a patient from non-medical data retrieved from a social network service, and for sending a health advice message to an electronic device associated with the patient. In the discussion below, a reference to the process 200 performing or doing some function or action refers to one or more controllers or processors that are configured to execute programmed instructions to implement the process performing the function or action or to operate one or more components to perform the function or action. Process 200 is described with reference to the system 100 of FIG. 1 for illustrative purposes.

During process 200, the telehealth system 150 performs a login process to gain access to the social network service (block 204). In the telehealth system 150, the processor 154 retrieves stored account credentials 170 from the memory 150. In one embodiment the account credentials 170 include a username and password for an account with the social network 120 that is specifically for use of the telehealth system 150. The account data 170 also include an identifier, such as a username, for the patient 102 to enable the account for the telehealth system 150 to identify social data that correspond to the patient 102. In one configuration, the account for the telehealth system 150 is established at the time that the patient 102 is enrolled for telehealth treatment, or at a later time when the patient 102 uses the social network 120 and the healthcare professional 184 establishes the account for the telehealth system 150 with the social network service 120. In some social network service embodiments, the patient 102 uses an interface provided by the social network service 120 to establish a relationship between the user account for the patient 102 and the user account for the telehealth system 150. The relationship enables the user account for the telehealth system 150 to retrieve data corresponding to the patient 102 on the social network service 120 that is not otherwise publicly available for retrieval. Some social network services do not require the telehealth system 150 to have a specific login account to retrieve posted data from the patient 102. For example, some social network services enable the patient 102 to post publicly-viewable comments and messages. The telehealth system 150 stores an identifier for the patient in the social network account data 170, but does not require a separate account with the social network service 120. As described above, the patient 102 may use multiple social network services, and the telehealth system 150 is configured to store appropriate account credentials for multiple social network services to enable the telehealth system 150 to retrieve data corresponding the patient 102 from multiple social network services.

Process 200 continues as the telehealth system 150 retrieves non-medical data from the social network service 120 (block 208). In the embodiment of FIG. 1, the processor 154 retrieves data corresponding to some or all of the posts 124, messages 128, data from applications 132, location 136, and events 140 that correspond to the patient 102 on the social network service 120. The processor 154 stores the retrieved data in the social network patient database 172 for additional analysis in identifying health characteristics of the patient 102 from the data on the social network service 120. In one embodiment, the telehealth system 150 retrieves data from the social network service 120 in a “polling” configuration, while in another embodiment the social network service 120 sends data to the telehealth system 150 in a “push” configuration. In some embodiments, the processor 154 deletes the social network data after a predetermined time to enable analysis of health characteristic data over a predetermined time period (e.g. one week or one month) and to preserve the privacy of the patient 102. The processor 154 optionally encrypts the patient social network data 172 and stores the encrypted data to storage in the memory 164 to deter unauthorized access to the data.

In one embodiment, the telehealth system 150 only retrieves text data or structured data such as encoded location data for the patient 102 from the social network service 120. Examples of text data include any postings or messages that the patient 102 sends from the smartphone 108 or PC 112 to the social network service, including text corresponding to emoticons. Structured data often include extensible markup language (XML) data structures that are associated with automated services, such as location data 136 and application data 132, which are generated from software programs associated with the social network service 120. The processor 154 analyzes the text data using, for example, regular expressions, natural language processing, keyword analysis, and other existing analytical techniques to identify health characteristics for the patient 102. The structured data are analyzed using, for example, predetermined XML schema and document type descriptors (DTDs) that the processor 154 uses to extract predetermined data elements from the XML data. The text data and structured data are highly compressible for efficient storage in the memory 164 and provide sufficient information to identify health characteristics in some embodiments.

In an alternative embodiment, the telehealth system 150 also retrieves photographs, video, audio, and other unstructured data corresponding to the patient 102 from the social network service 120. The processor 154 performs facial recognition analysis to identify the patient 102 in photographs and video, and voice recognition analysis to identify the voice and speech content of the patient 102 in audio data posted on the social network service 120. In still another embodiment, the processor 154 retrieves photographs, video, and audio from the social network service, but the processor 154 extracts structured metadata, such as EXIF metadata, from the media and discards the content of the media. The metadata provide additional information about the patient 102, such as the location of the patient 102 and the time of generation for the photographs, audio, or video, without requiring extensive processing of the content of the media and without requiring sufficient storage capacity to store the fully media data in the memory 164.

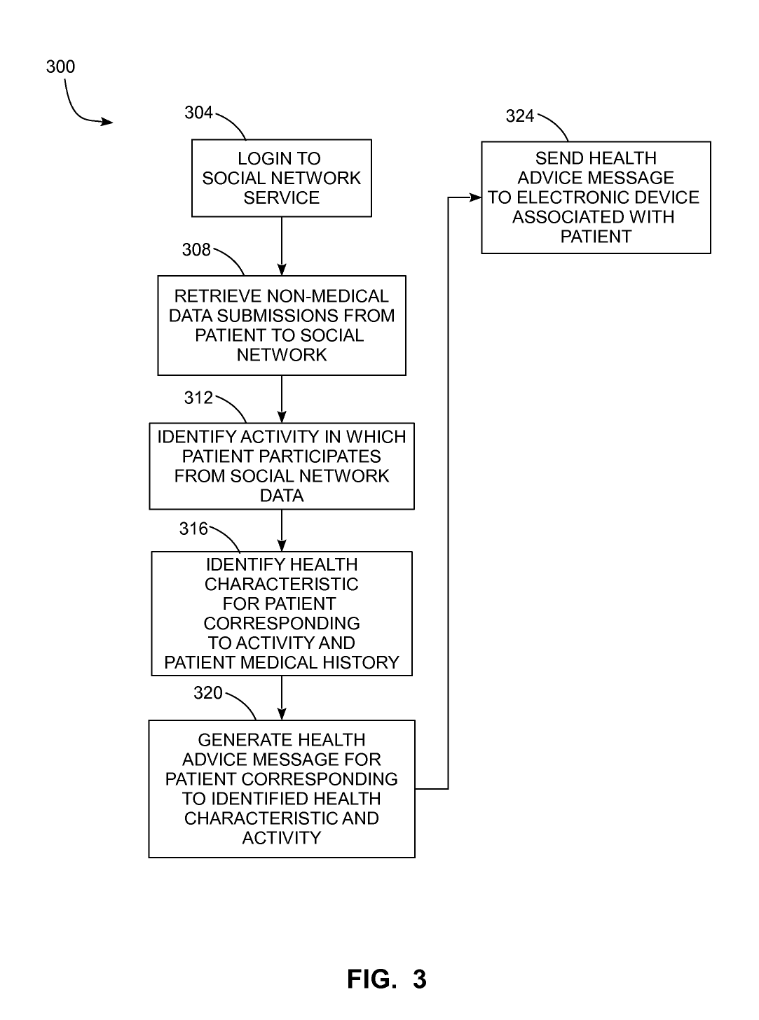

Referring again to FIG. 2, process 200 continues as the telehealth system identifies at least one health characteristic pertaining to the patient from the data that are retrieved from the social network service (block 212). A telehealth system is configured to identify one or more health characteristics from the non-medical social network data. In the embodiment of FIG. 1, the processor 154 in the telehealth system 150 analyzes the non-medical patient data 172 with different hardware and software modules to identify activities in which the patient 102 participates (module 156), the location of the patient, and whether the patient is changing location due to, for example, travel (module 158), and the mental state of the patient (module 160). The processor 154 can identify the health characteristic from a single datum that is retrieved from the social network service 120, or from a composite of multiple pieces of data, which are retrieved from different sections of the social network service 120 or from multiple social network services. Some items of data are assigned higher relevance and reliability scores than other items of data. For example, metadata and machine-generated data, such as location data received from a GPS device, can be assigned a high likelihood of being accurate. A single comment or posting that the patient 102 sends to the social network service 120 may, however, have a lower likelihood of being relevant to a health characteristic of the patient 102. Instead, the telehealth system 150 analyzes multiple posts, messages, comments, and other data about the patient 102 to identify health characteristics while reducing the likelihood of misidentifying the health characteristics from the social network data. More specific examples of processes for identifying these health characteristics are described in detail with reference to FIG. 3-FIG. 6.

Referring again to FIG. 2, the process 200 continues as the telehealth system 150 generates a health advice message that corresponds to both the identified health characteristic and the medical records for the patient 102 (block 216). In the telehealth system 150, the processor 154 performs a search in the patient medical records 168 to identify diagnosed medical conditions or other information about the patient 102 that present an issue with the identified health characteristic. For example, if an identified location health characteristic indicates that the patient 102 is or will be traveling away from home, then the processor 154 identifies a list of prescription medications in the patient medical record data 168 and generates a message including a reminder for the patient 102 to be sure to have a sufficient supply of the medications. In the telehealth system 150, the memory 164 stores a plurality of predetermined health advice messages 174. The health advice messages 174 include both generic health advice messages, such as general dietary and exercise messages that apply to a large number of patients, and optionally includes health advice messages that the healthcare professional 184 writes specifically for the patient 102. The processor 154 selects one of the predetermined health advice messages 174 for some of the health characteristics identified for the patient. In one configuration, the processor 154 identifies a health characteristic corresponding to hunger in the patient 102 is hungry in response to retrieving posts about food from the social network service 120. The processor 154 selects a predetermined nutrition message from the health advice message data 174 to generate a message for the patient 102 that provides a nutritious meal option.

For some health characteristics, the processor 154 optionally retrieves additional data from one or more online information services 180 to identify the health characteristic and to generate the health advice message. Examples of online information services 180 include, but are not limited to, search engines, mapping and geographic services, web sites of restaurants and grocery stores, public health databases, and the like. The online information services 180 provide additional information beyond the data that are provided through the social network service 120. In one configuration, the processor 154 identifies a potential health characteristic for the patient 102 from the social network data 172 that are retrieved from the social network services 120. The social network data 172 often include enough information to identify a general health characteristic of the patient, and the additional data from the information services 180 provide details that the patient 102 does not post to the social network service. For example, as described in more detail below, if the patient 102 submits information about eating at a restaurant, then the telehealth system 150 accesses menu and nutritional information from a website for the restaurant to identify if the food served at the restaurant presents health issues for the patient 102.

In the process 200, the telehealth system sends the generated health advice messages to an electronic device that is associated with the patient 102 (block 220). In the telehealth system 150, the processor 154 retrieves contact data 168 that correspond to one or more electronic devices that are associated with the patient 102. For example, in different embodiments the contact data include phone numbers, email addresses, instant messaging service user names, and the username of the patient for the social network service 120. The telehealth system 150 sends the health advice message to one or more of the accounts that are associated with the electronic devices to ensure that the patient 102 receives the health advice message. For example, in one embodiment the telehealth system 150 sends a simple messaging service (SMS) text message to the smartphone 108 and in another embodiment the telehealth system 150 calls the smartphone 108 and relays the health advice message aurally using a speech synthesis module. In another embodiment, the telehealth system 150 sends an email to an email address associated with the patient 102 for display with the smartphone 108 or PC 112. In another embodiment, the telehealth system 150 sends the health advice message to the smartphone 108 or PC 112 using a messaging function of the social network 120 to reach the patient 102, or another messaging service such as an instant messaging service. In another embodiment, the telehealth system 150 sends the health advice message to the telehealth terminal 104.

FIG. 3 depicts a process 300 for identifying a health characteristic for an activity in which a patient participates from data that the patient submits to the social network service 120. In the discussion below, a reference to the process 300 performing or doing some function or action refers to one or more controllers or processors that are configured to execute programmed instructions to implement the process performing the function or action or to operate one or more components to perform the function or action. Process 300 is described with reference to the system 100 of FIG. 1 and the activity identification module 156 depicted in FIG. 7 for illustrative purposes.

Process 300 begins when the telehealth system 150 performs a login to access data corresponding to the patient 102 provided by the social network service 120 (block 304) and retrieves non-medical data that the patient submits to the social network service 120 (block 308). During process 300, the telehealth system 150 performs the processing of blocks 304 and 308 in substantially the same manner as described above with reference to the processing performed in blocks 204 and 208, respectively, of the process 200.

Process 300 continues as the telehealth system 150 identifies an activity in which the patient 102 participates from the data that are retrieved from the social network service 120 (block 312). In the telehealth system 150, the processor 154 includes hardware and software module 156 for the identification of activities and generation of health advice messages for the activities. In one embodiment, the telehealth system 150 identifies activities from event data 140 that the telehealth system 150 retrieves from the social network 120. Each event typically includes data corresponding to the type of event, location of the event, and the time at which the event occurs. The patient 102 submits an RSVP message to indicate if the patient 102 will participate in the event. The processor 154 in the telehealth system 150 identifies the type of event using, for example, natural language processing or a keyword search of a description that is provided for the event. The processor 154 optionally retrieves additional information from an online information service 180, such as a search engine, to identify the activity. The processor 154 categorizes the activity based on different health parameters for the patient 102. For example, if the activity includes the keyword “kayaking” then the processor 154 identifies that the activity includes strenuous physical activity. In another example, a party or other social gathering often includes the consumption of food. The processor 154 categorizes the identified activities to identify aspects of the activity that have the potential to affect the health of the patient 102.

After identification of the activity, the telehealth system 150 identifies a health characteristic of the patient 102 that corresponds to the activity (block 316). In the telehealth system 150, the processor 154 identifies diagnosed medical conditions and symptoms for the patient 102 in the patient medical record data 168. The processor 154 identifies aspects of the diagnosed conditions that are affected by the categories of the activity. For example, the kayaking activity is physically strenuous, and if the medical record data 168 indicate that the patient 102 has a heart condition, then strenuous activity affects the health of the patient 102. The telehealth system 150 identifies both positive and negative effects of an activity on different health characteristics of the patient 102. For example, if the patient medical record data 168 indicate that the patient 102 is overweight, then an activity involving moderately strenuous physical exertion has a positive effect on the overall health of the patient 102.

Process 300 continues as the telehealth system 150 generates a health advice message that corresponds to the identified health characteristic for the patient and the activity of the patient (block 320). The processor 154 generates the content of the health advice message for the type of activity and the medical records of the patient. For example, the telehealth system 150 can generate warning messages for the patient 102 if the activity has a negative impact on one or more of the health characteristics. In another instance, the processor 154 generates a message including advice for performing the activity in a recommended manner. For example, if the telehealth system 150 identifies that the patient 102 will participate in a running or bicycling event, the telehealth system 150 sends a message including recommended stretching exercises for the patient 102. The telehealth system 150 is further configured to generate an encouragement message for the patient 102 if the identified activity corresponds to an activity that is recommended by the healthcare professional 184.

Process 300 continues as the telehealth system 150 sends the generated health advice message to the electronic device associated with the patient 102 (block 324). The telehealth system 150 sends the health advice message to the electronic device that is associated with the patient in substantially the same manner as described above with reference to the processing of block 220 in the process 200.

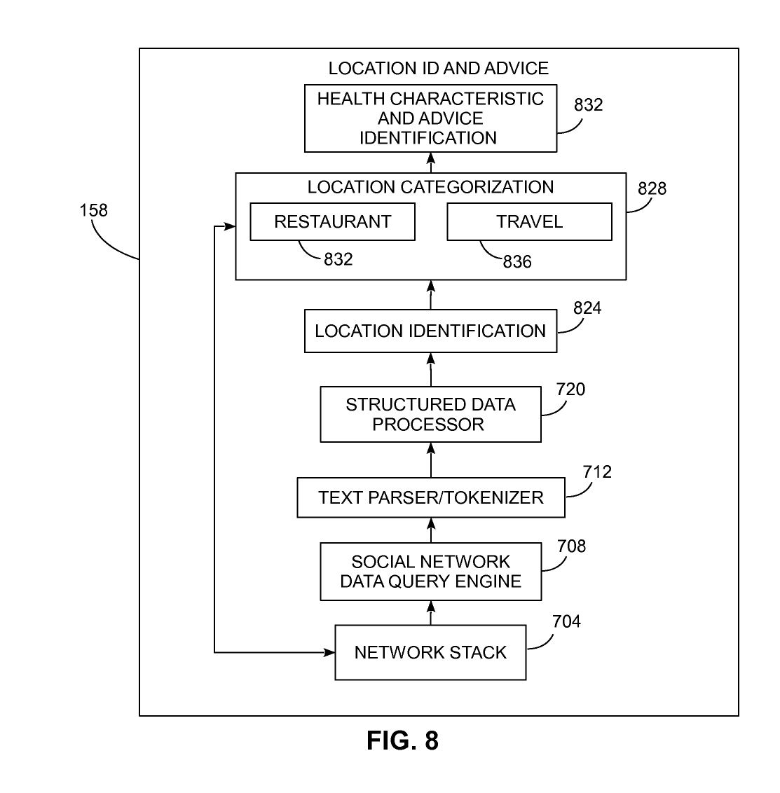

FIG. 8 depicts the location identification and advice module 158 in the telehealth system 150. FIG. 8 includes functional elements that are embodied as a combination of digital processing hardware and software components in the telehealth system 150. The module 158 includes the network stack 704, social network data query engine 708, text parser/tokenizer 712, and structured data processor 720 that are described above with reference to FIG. 7. The module 158 also includes a location identification module 824, a location categorization module 828, and a health characteristic and advice identification module 732.

In the module 158, the location identification module 824 receives structured location data from the structured data processor 720. In one embodiment, telehealth system 150 retrieves the structured location data 136 from the social network 120. The structured location data include geographic coordinates, such as latitude/longitude coordinates, or other structured location information, such as a street address corresponding to the location of the patient 102.

In the module 158, the location categorization module 828 identifies properties about the location of the patient 102 that have an effect on health characteristics for the patient 102. In one embodiment, the location categorization module 828 identifies businesses and landmarks that are at or near the identified location for the patient 102, and identifies the distance between the patient 102 and a predetermined home address for the patient 102 that is stored with the patient medical record data 168. In the embodiment of FIG. 8, the location categorization module 828 includes a “restaurant” sub-module 832 that is configured to identify whether the patient 102 is located at a restaurant, and to further retrieve nutritional information about menu items available at the restaurant for generation of a dietary health advice message. The location categorization module 828 also includes a “travel” sub-module 836 that identifies whether the location of the patient 102 is greater than a predetermined distance from home and retrieves information about medical and recreational services near the location of the patient 102.

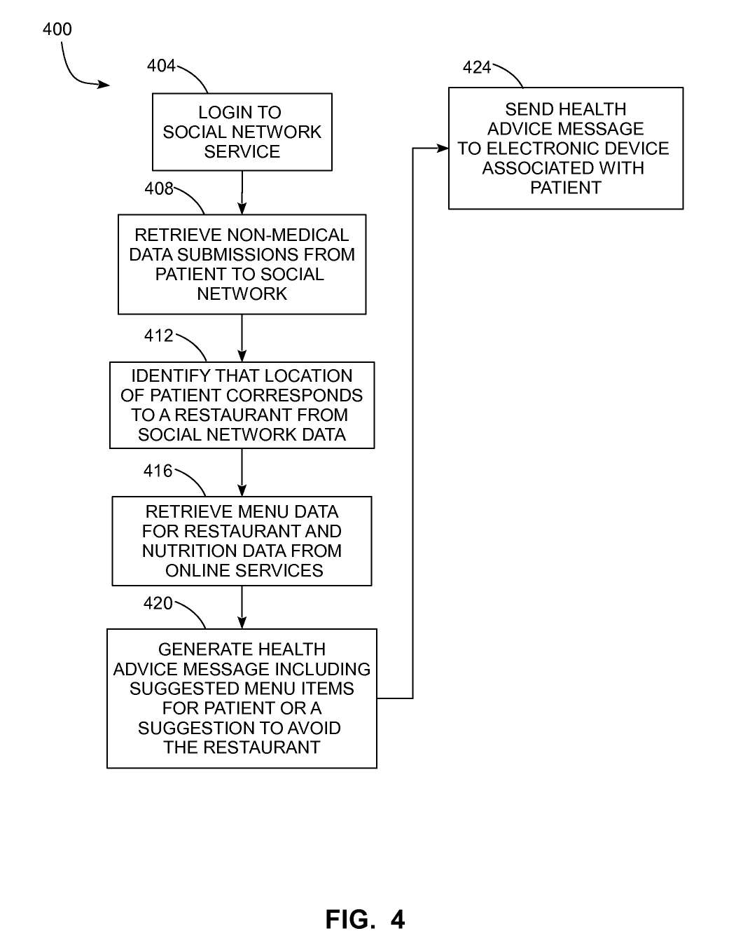

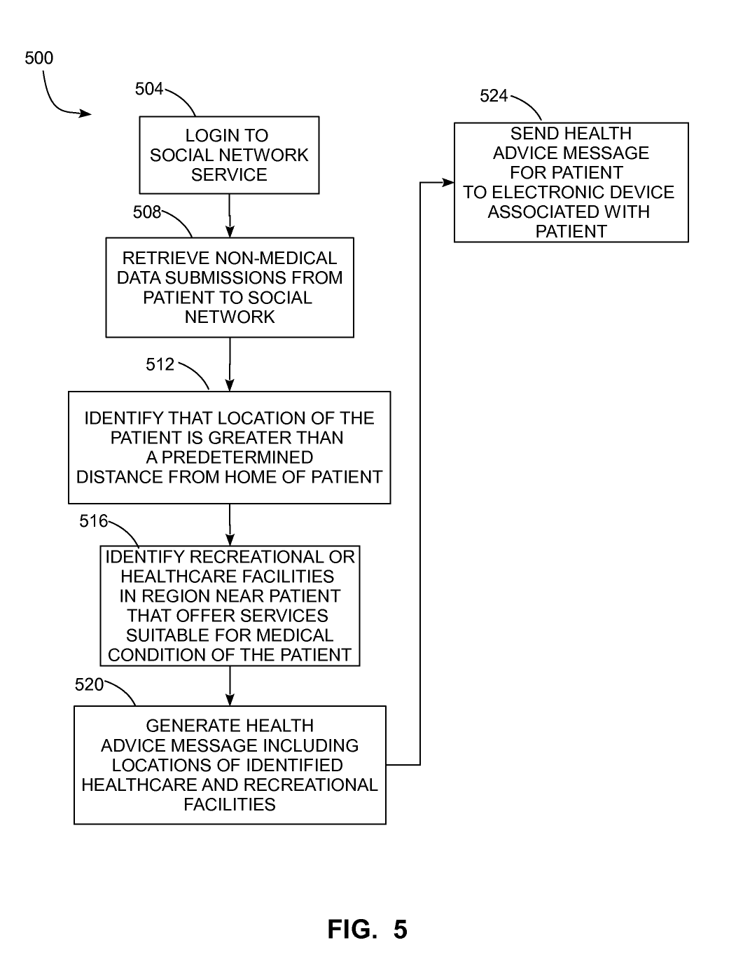

In the module 158, the health characteristic and advice module 832 identifies health characteristics for the patient 102 that are affected by the location of the patient 102 and the diagnosed medical conditions for the patient 102 that are stored in the patient medical record data 168. For example, as described below in FIG. 4, the health characteristic and advice module 832 generates a health advice message with menu recommendations for the patient 102 based on the dietary recommendations for the patient 102 and on the menu items available at a restaurant where the patient 102 dines. As described below in FIG. 5, the health characteristic and advice module 832 generates recommendations for nearby healthcare and recreational facilities that provide services that cater to the diagnosed medical conditions of the patient 102 when the patient 102 is traveling away from home.

In addition to identifying activities in which the patient participates, the telehealth system 150 identifies the location of the patient at different times and generates health advice messages corresponding to the location and the diagnosed medical conditions for the patient. FIG. 4 depicts a process 400 for identifying a health characteristic corresponding to a location of a patient when the location of the patient corresponds to a restaurant. Since many patients who undergo telehealth treatment have recommended diets or dietary restrictions, one aspect of the telehealth treatment is to recommend appropriate food for consumption when the patient dines in a restaurant. In the discussion below, a reference to the process 400 performing or doing some function or action refers to one or more controllers or processors that are configured to execute programmed instructions to implement the process performing the function or action or to operate one or more components to perform the function or action. Process 400 is described with reference to the system 100 and the location identification and advice module 158 depicted in FIG. 8 of FIG. 1 for illustrative purposes.

Process 400 begins when the telehealth system 150 performs a login to access data corresponding to the patient 102 provided by the social network service 120 (block 404) and retrieves non-medical data that the patient submits to the social network service 120 (block 408). During process 400, the telehealth system 150 performs processing for blocks 404 and 408 in substantially the same manner as the processing described above with reference to blocks 204 and 208, respectively, of the process 200.

During process 400, the telehealth system 150 identifies the location of the patient 102 from, for example, the location data 140 that are retrieved from the social network service 120. When the location of the patient 102 corresponds to a restaurant, the telehealth system 150 identifies the restaurant using the location data (block 412). In the telehealth system 150, the processor 154 includes hardware and software module 158 for the identification of the health characteristics for the location of the patient and generation of health advice messages for the location. In some embodiments, the location data are geographical coordinates, such as latitude/longitude coordinates. The processor 154 accesses an online mapping service 180 to identify a restaurant that is located at the geographical coordinates. In another embodiment, the location data include the name of the restaurant or the telehealth system 150 identifies that the patient 102 is dining in a particular restaurant from additional data that are retrieved from the social network service 120.

After identifying the restaurant in which the patient 102 dines, the telehealth system 150 retrieves a menu for the restaurant and other nutritional data from the online services 180 (block 416). Many restaurants place menus on websites or other data services that are connected to the data network 192. The processor 154 in the telehealth system 150 retrieves the menu data corresponding to the restaurant and identifies menu items that are available at the restaurant. Some restaurants also provide detailed nutritional information for different menu items, and the telehealth system 150 retrieves the nutritional information to identify menu items that are appropriate for dietary recommendations that are stored in the patient medical record data 168. Many restaurants do not provide detailed nutritional information for menu items, and the processor 154 applies heuristics to estimate the nutritional content of a menu item. For example, in one embodiment the telehealth system 150 retrieves generic nutritional data from an online database 180 to estimate the nutritional content of a menu item when the menu item is commonly served by many restaurants. In another embodiment, the processor 154 identifies keywords and phrases that are indicative of the nutritional content of a menu item. For example, the keywords “fried” or “sweet” can indicate unhealthful menu items while terms such as “fresh” and the names of vegetables can indicate more healthful menu items.

Process 400 continues as the telehealth system 150 generates a health advice message for the patient 102 using nutrition information corresponding to menu items at the restaurant and the medical record data 168 corresponding to the patient 102 (block 420). For example, if the patient 102 is diagnosed with high cholesterol, then the telehealth system 150 identifies menu items with low cholesterol and saturated fat content for recommendation to the patient 102. In another example, if the patient 102 is diagnosed with diabetes, then the telehealth system 150 identifies menu items with low sugar content for recommendation to the patient 102. In some instances, the telehealth system 150 identifies that none of the menu items that are available at the restaurant are recommended for consumption by the patient 102. The telehealth system 150 generates a warning message for the patient 102 to avoid eating at the restaurant. In one embodiment, the telehealth system 150 identifies different restaurants that are within a predetermined distance of the patient 102 using data from the online mapping service 180 in response to the restaurant at the location corresponding to the patient failing to offer appropriate menu items. The telehealth system 150 identifies at least one of the nearby restaurants that offers appropriate menu items and includes a recommendation to visit the identified restaurant in the generated health advice message.

After generating the health advice message, the telehealth system 150 sends the health advice message to the electronic device associated with the patient 102 (block 424). During process 400, the telehealth system 150 sends the health advice message to the electronic device that generates the location information corresponding to the patient 102. For example, in the system 100, the smartphone 108 sends geolocation information to the social network service 120, and the patient 102 carries the smartphone 108 during a visit to the restaurant. The telehealth system 150 sends the health advice message to a communication service that the patient 102 accesses through the smartphone 108 to enable the patient 102 to receive the health advice while at the restaurant.

Some patients that receive telehealth treatment travel to locations where the patients do not have immediate access to healthcare and recreational facilities that the patients frequent when at home. FIG. 5 depicts a process 500 for identifying a health characteristic corresponding to a location of a patient when the patient is greater than a predetermined distance from a home address and for generating health advice messages for the patient. In the discussion below, a reference to the process 500 performing or doing some function or action refers to one or more controllers or processors that are configured to execute programmed instructions to implement the process performing the function or action or to operate one or more components to perform the function or action. Process 500 is described with reference to the system 100 of FIG. 1 and the location identification and advice module 158 depicted in FIG. 8 for illustrative purposes.

Process 500 begins when the telehealth system 150 performs a login to access data corresponding to the patient 102 provided by the social network service 120 (block 504) and retrieves non-medical data that the patient submits to the social network service 120 (block 508). During process 500, the telehealth system 150 performs the processing of blocks 504 and 508 in substantially the same manner as the processing described above with reference to blocks 204 and 208, respectively, of the process 200.

During process 500, the telehealth system 150 identifies the location of the patient 102 from, for example, the location data 140 that are retrieved from the social network service 120. In the telehealth system 150, the processor 154 includes hardware and software module 158 for the identification of the health characteristics for the location of the patient and generation of health advice messages for the location. The processor 154 measures a distance between the identified location of the patient 102 and a predetermined home address of the patient that is stored with the patient medical record data 168 in the memory 164. In one embodiment, the telehealth system 150 measures the distance between the location of the patient and the home of the patient using an online mapping service 180. During process 500, the processor 154 identifies that the location of the patient 102 is greater than a predetermined distance from the home address of the patient (block 512). For example, if the location of patient 102 is more than 100 kilometers from the home address for the patient 102, then the telehealth system 150 identifies that the patient 102 is traveling and generates health advice messages for the patient 102.

During process 500, the telehealth system 150 identifies healthcare and recreational facilities that are within a predetermined distance around the patient 102 and that are equipped to provide services for the patient 102 (block 516). For example, in one embodiment the telehealth system 150 identifies medical facilities that are within a predetermined distance of the identified location of the patient 102 using an online mapping service 180. The telehealth system 150 then identifies the types of treatment that the patient 102 is most likely to require from the patient medical record data 168 that are stored in the memory 164. For example, if the medical record data 168 indicate that the patient 102 requires a dialysis procedure, then the telehealth system 150 further identifies medical facilities that provide dialysis procedures. Recreational facilities include parks, swimming pools, physical therapy, and fitness facilities where the patient 102 can perform exercises or other recommended physical activities. If the patient medical record data 168 indicate that the patient 102 should perform a particular exercise, such as walking, then the processor 150 further identifies recreational facilities where the patient 102 can perform the recommended exercise.

Process 500 continues as the telehealth system 150 generates a health advice message that includes the locations of the identified healthcare and recreational facilities that are near the location of the patient 102 (block 520). In one embodiment, the message includes the names and street addresses of the healthcare and recreational facilities. In another embodiment, the telehealth system 150 generates an encoded message with, for example, a hyperlink that enables the patient 102 to view a map with markers that depict the identified facilities using, for example, the smartphone 108. Since existing smartphones often include mapping and navigation features, the health advice message enables the patient 102 to select a nearby health or recreational facility and navigate to the facility in an efficient manner.

After generating the health advice message, the telehealth system 150 sends the health advice message to the electronic device associated with the patient 102 (block 524). During process 500, the telehealth system 150 sends the health advice message to the electronic device that generates the location information corresponding to the patient 102. For example, in the system 100, the smartphone 108 sends geolocation information to the social network service 120, and the patient 102 carries the smartphone 108 while traveling. The telehealth system 150 sends the health advice message to a communication service that the patient 102 accesses through the smartphone 108 to enable the patient 102 to receive the health advice while traveling.

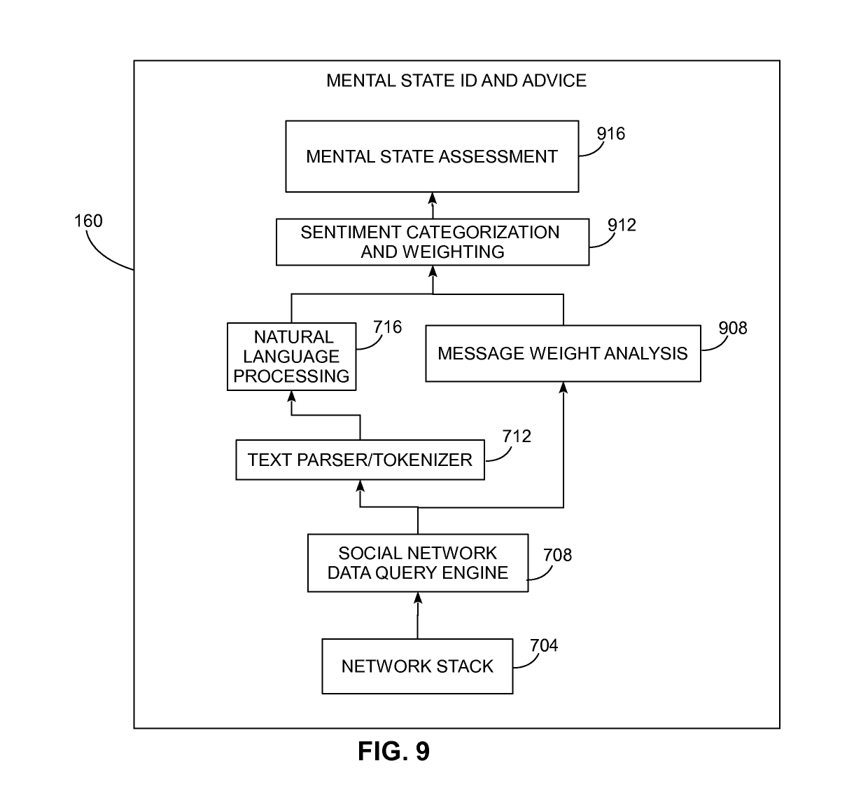

FIG. 9 depicts the mental state identification and advice module 160 in the telehealth system 150. FIG. 9 includes functional elements that are embodied as a combination of digital processing hardware and software components in the telehealth system 150. The module 160 includes the network stack 704, social network data query engine 708, text parser/tokenizer 712, and natural language processor 716 that are described above with reference to FIG. 7. The module 160 also includes a message weight analysis module 908, a sentiment weight and categorization module 912, and a mental state assessment module 916.

In the module 160, the natural language processor 716 is configured to perform a sentiment analysis on unstructured text that is submitted to the social network 120 by the patient 102. Sentiment analysis is a subset of natural language processing that is directed to identification of the emotions and feelings expressed in text. As described below, the natural language processor 716 is also configured to identify emoticons in the unstructured text and assess the sentiment of the text from the contents of the emoticons and predetermined emotions and sentiments that are associated with the emoticons.

In the module 160, the message weight analysis module 908 assigns a weight to each set of unstructured text that is used to identify the mental state of the patient 102. The assigned weight corresponds to an identified credibility of each set of text in assessing the overall mental state of the patient 102. In one embodiment, the weight analysis module 908 assigns a numeric weight value to the sentiment that is identified for each set of text. For example, in the social network 120, the patient 102 submits posts 124 and messages 128. If a post or message is submitted without prompting from another user of the social network service 120, then the weight analysis module 908 assigns a stronger weight to the unprompted post or message in comparison to a post or message that is sent in reply to another user of the social network service 120. Additionally, the weight analysis module 908 is configured to assign a weight to posts and messages in proportion to the length of the post or message, with longer posts and messages receiving a greater weight value.

In the module 160, the sentiment categorization and weighting module 912 combines both the identified sentiment in the unstructured text that is identified from the natural language processing module 716 and the weight that is assigned to the text from the message weight analysis module 908. The sentiment categorization and weighting module 912 aggregates the weighted sentiments for multiple unstructured text entries together over time as the patient 102 submits data to the social network service 120. In one configuration, the sentiment categorization and weighting module applies additional weight discounting to identified sentiments over time to discount the sentiments that are expressed in older sets of text and to assign a greater sentiment weight to more recent submissions from the patient 102. The sentiment categorization and weighting module 912 identifies an overall mental state for the patient 102 using the text from multiple submissions to the social network service 120 to improve the accuracy of the identification. For example, the mental and emotional state of many patients varies from hour to hour or day to day based on normal daily experiences. The sentiment and categorization weighting module 912 identifies the mental state of the patient 102 over a longer period of time to identify the underlying mental state of the patient 102 while discounting short-term variations in the mental state for the patient 102.

In the module 160, the mental state assessment module 916 uses the identified mental state of the patient 102 from the sentiment categorization and weighting module 912 and the diagnosed medical conditions of the patient 102 from the patient medical record data 168 to identify whether the mental state of the patient 102 is deteriorating. As described in more detail below, the term deterioration refers to any change in the mental state of the patient 102 that is of medical interest to the medical professional 184. In one embodiment, the mental state assessment module 916 identifies an expected range of mental states for the patient 102 from the diagnosed medical conditions and the medical history in the medical record data 168 for the patient 102. If the identified mental state for the patient 102 from the sentiment and categorization weight module 912 indicates that the mental state of the patient 102 is deviating from the expected range of mental states, then the telehealth system 150 is configured to generate an alert message for the healthcare professional 184.

In many telehealth treatment programs, the mental state of the patient is an important factor in the successful outcome of the telehealth treatment. If the patient feels discouraged, then the patient is less likely to follow the advice of healthcare professionals and experience success during the treatment program. Some telehealth devices generate direct questions for the patient pertaining to the mental state of the patient. For example, the telehealth devices ask questions to identify if the patient is happy, sad, depressed, discouraged, and to alert a healthcare professional if the mental state of the patient deteriorates. Direct questions, however, are not always effective at identifying the mental state of the patient in an accurate manner. In the system 100, the telehealth system 150 identifies an emotional state of the patient 102 from the non-medical data that the patient 102 submits to the social network service 120. The patient 102 submits the non-medical data in a less formal manner than during a telehealth treatment course, and the social network service 120 provides a more conducive environment for the patient 102 to express emotions.

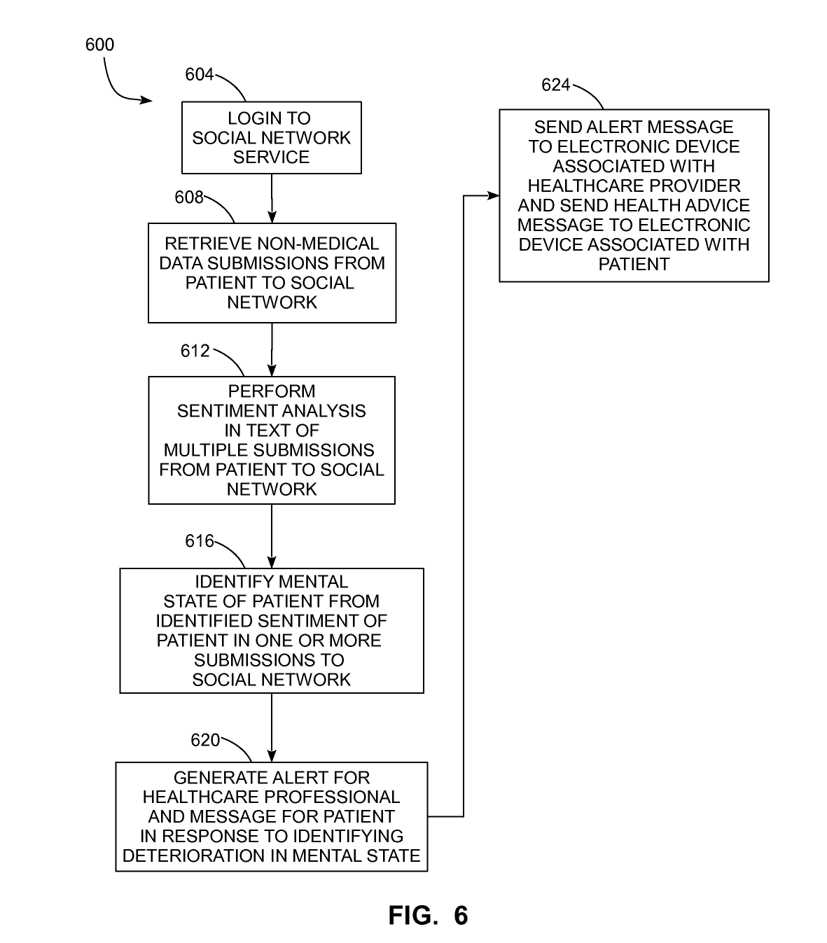

FIG. 6 depicts a process 600 for identification of a mental state of the patient 150 using the non-medical data that are retrieved from the social network service 120 and for generation of alert messages for healthcare professionals and optional generation of health advice messages for the patient 102 based on the identified mental state of the patient 102. In the discussion below, a reference to the process 600 performing or doing some function or action refers to one or more controllers or processors that are configured to execute programmed instructions to implement the process performing the function or action or to operate one or more components to perform the function or action. Process 600 is described with reference to the system 100 of FIG. 1 and the mental state identification and advice module 160 of FIG. 9 for illustrative purposes.

Process 600 begins when the telehealth system 150 performs a login to access data corresponding to the patient 102 provided by the social network service 120 (block 604) and retrieves non-medical data that the patient submits to the social network service 120 (block 608). During process 500, the telehealth system 150 performs the processing of blocks 604 and 608 in substantially the same manner as the processing described above with reference to blocks 204 and 208, respectively, of the process 200.

Process 600 continues as the telehealth system identifies performs a sentiment analysis process on the data that are retrieved from the social network 120 (block 612). In the telehealth system 150, the processor 154 includes a mental state identification module 160 including hardware and software components that perform the process 600. As used herein, the term sentiment analysis refers broadly to any text analysis technique that identifies an emotional sentiment that is expressed in the text. Sentiment analysis is performed as part of natural language processing to extract information from text written by humans that is meaningful to an automated system, such as the telehealth system 150. During process 600, the processor 154 performs the sentiment analysis process on one or more individual posts 124 and messages 128 that the patient 102 submits to the social network service 120. The processor 154 identifies a sentiment for each message as part of assessing the mental state of the patient 102. The sentiment expressed in an individual message does not necessarily reflect the overall mental state of the patient 102, but taken in the aggregate the sentiment in multiple submissions can indicate the overall mental state of the patient 102 over time.

Many users of social network services express emotions using emoticons. In one embodiment of the process 600, the processor 154 performs sentiment analysis on each of the posts and messages that are received from the social network service 120 using the emoticons to identify the sentiment of each message. Emoticons generally correspond to well-defined emotional states, and are often less ambiguous than other words used in English and other languages to express sentiment. For example, the emoticon :-) corresponds to a smiling face and indicates happiness, while the emoticon :-( corresponds to a frowning face and indicates sadness. Various other emoticons are commonly used to express a wide range of emotions. In one embodiment, the process 154 identifies emoticons that are included in the posts and messages that the patient 102 submits to the social network. The processor 154 assigns sentiment values based on the types of identified emoticons and on the frequency of different emoticons. For example, if the patient 102 makes a large number of posts that include emoticons corresponding to sadness and anger, then the identified sentiment for the posts also correspond to sadness and anger. Some posts and messages that do not include emoticons are considered to be neutral.

Process 600 continues as the telehealth system identifies an overall mental state of the patient from a plurality of submission to the social network 120 (block 616). As described above, the overall mental state of the patient 102 may not be fully expressed by an individual post or message. For example, the patient 102 submits a post describing a honor movie as being frightening. The identified sentiment for the post indicates that the patient 102 is expressing fear and anxiety, but the post is not actually indicative of the overall mental state of the patient 102. If, however, a large number of submissions from the patient 102 indicate similar sentiments, and if similar sentiments are expressed through the course of several days or weeks, then the processor 154 uses the aggregate sentiments to identify the mental state of the patient 102. In some instances, if a large proportion of the submissions to the social network service 120 include a neutral sentiment, then the processor 154 discounts a comparatively small number of messages with strong sentiments when assessing the mental state of the patient 102.

During process 600, the telehealth system 150 generates alert messages for healthcare professionals, such as the healthcare professional 184, and health advice messages for the patient 102 if the telehealth system 150 identifies that the mental state of the patient 102 is deteriorating (block 620). In the telehealth system 150, the patient medical record data 168 store diagnosed psychiatric conditions for the patient 102 and store a history of the mental state of the patient 102 over the course of the telehealth treatment. As used herein, the term “deterioration” is used broadly to indicate any change in the mental state of the patient 102 that is of concern to a mental health professional. For example, in a patient without a history of psychiatric illness, a prolonged period of depression or anger indicates deterioration in the mental state of the patient. In another patient who has a history of depression, a depressed mental state may be expected as part of a course of treatment, but if the mental state of the patient indicates a sudden euphoria, then the seemingly positive change in mental state can also be indicative of a condition that requires treatment.

In the telehealth system 150, the processor 154 sends an alert message for the healthcare professional 184, and optionally sends a health advice message to the electronic device that is associated with the patient (block 624). The alert message identifies the patient 102 and includes a brief description of the deterioration in the mental state of the patient 102. The telehealth system 150 sends the alert message through the network 192 to an electronic device associated with the healthcare professional, such as the PC 186 and smartphone 188 that are depicted in FIG. 1. In one embodiment, the telehealth system 150 sends a health advice message to the electronic device that is associated with the patient 102 in a similar manner to the processing described above with reference to block 220 in FIG. 2. In one embodiment the process 600, the health advice message instructs the patient 102 to contact the healthcare professional 184 for additional treatment.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A method for assessment of a patient comprising:
receiving with a processor communicatively connected to a data network non-medical data corresponding to a patient from a social network service that is connected to the data network;
identifying with the processor a health characteristic of the patient in the non-medical data received from the social network service;
generating with the processor a message including health advice associated with the identified health characteristic of the patient; and
sending with the processor the message to an electronic device associated with the patient through the data network.

2. The method of claim 1, the identification of the health characteristic further comprising:
identifying with the processor a location of the patient in the non-medical data received from the social network service.

3. The method of claim 2, the generation of the message further comprising:
generating the message with health advice that includes a recommendation for a menu item to order in response to the identified location being a restaurant.

4. The method of claim 2, the generation of the message further comprising:
generating the message with health advice that includes an alert that a restaurant does not serve food that complies with a diet for the patient in response to the identified location being the restaurant.

5. The method of claim 2, the generation of the message further comprising:
generating the message with health advice that includes a location of a healthcare facility that is within a first predetermined distance of the location of the patient in response to the identified location of the patient being greater than a second predetermined distance from a predetermined location of a home of the patient.

6. The method of claim 1, the identification of the health characteristic further comprising:
identifying with the processor an activity of the patient in the non-medical data received from the social network service.

7. The method of claim 6, the generation of the message further comprising:
generating the message with health advice that includes a recommendation for performing the activity in a manner that complies with a diagnosed medical condition for the patient.

8. The method of claim 1, the identification of the health characteristic further comprising:
identifying with the processor a mental state of the patient in the non-medical data received from the social network service.

9. The method of claim 8, the identification of the mental state further comprising:
identifying with the processor a plurality of emoticons included in a plurality of postings made on the social network service by the patient; and
identifying the mental state of the patient with reference to identified emotional states that are associated with the plurality of emoticons.

10. The method of claim 8, the identification of the mental state further comprising:
performing with the processor a sentiment analysis operation on the non-medical data received from the social network with reference to text data in a plurality of postings made on the social network service by the patient; and
identifying the mental state of the patient with reference to an average sentiment identified from the analysis of the text of the plurality of postings.

11. The method of claim 8 further comprising:
generating with the processor an alert message in response to identifying a deterioration in the mental state of the patient; and
sending with the processor an alert message through the data network to an electronic device associated with a mental health professional who is treating the patient.

12. A system for assessment of a patient comprising:
a memory configured to store:
account credentials for an account on a social network service that is associated with another account used by the patient on the social network service;
medical record data corresponding to the patient including data corresponding to at least one diagnosed medical condition for the patient; and
address information identifying at least one of an account associated with the patient in the social network and an address identifier for an electronic device associated with the patient; and
a processor operatively connected to the memory and to a data network, the processor being configured to:
access the social network service through the data network with the account credentials stored in the memory to receive non-medical data corresponding to the account associated with the patient from the social network service;
identify a health characteristic of the patient in the non-medical data received from the social network service;
retrieve one of the plurality of health advice messages from the memory;
generate a message that includes health advice retrieved from the associated with the identified health characteristic of the patient; and
send the message to an electronic device corresponding to the address information in the memory through the data network.

13. The system of claim 12, the processor being further configured to:
send the message to the account associated with the patient on the social network service.

14. The system of claim 12, the processor being further configured to:
send the message to a network address associated with a mobile electronic device associated with the patient.

15. The system of claim 12, the processor being further configured to:
identify the health characteristic of the patient as a location of the patient in the non-medical data received from the social network service.

16. The system of claim 15, the processor being further configured to:
identify that the location of the patient corresponds to a restaurant;
retrieve a menu of the restaurant from an online service provider through the data network;
identify an item in the menu with a nutrition content that is recommended for consumption by the patient with reference to the medical record data in the memory;
generate the message with health advice including a recommendation for a menu item to order in response to the identified location being a restaurant.

17. The system of claim 15, the processor being further configured to:
identify that the location of the patient corresponds to a restaurant;
retrieve a menu of the restaurant from an online service provider through the data network;
identify that the menu includes no items that are recommended for consumption by the patient with reference to the medical record data in the memory;
generate the message with health advice including an alert that the restaurant does not serve food that complies with a diet for the patient.

18. The system of claim 15, the processor being further configured to:
identify that the location of the patient is greater than a first predetermined distance from a predetermined location of a home of the patient;
identify a location of a healthcare facility that provides services for treatment of the at least one diagnosed condition for the patient, the healthcare facility being within a second predetermined distance from the location of the patient; and
generate the message with health advice including the location of the healthcare facility.

19. The system of claim 12, the processor being further configured to:
identify the health characteristic of the patient as an activity of the patient in the non-medical data received from the social network service.

20. The system of claim 19, the processor being further configured to:
generate the message with health advice including a recommendation for performing the activity in a manner that complies with the diagnosed medical condition for the patient with reference to the medical record data in the memory.

21. The system of claim 12, the processor being further configured to:
identify the health characteristic of the patient as a mental state of the patient in the non-medical data received from the social network service.

22. The system of claim 21, the processor being further configured to:
identify a plurality of emoticons included in a plurality of postings made on the social network service by the patient; and
identify the mental state of the patient with reference to a plurality of emotional states that are associated with the plurality of emoticons.

23. The system of claim 21, the processor being further configured to:
perform a sentiment analysis operation on the non-medical data received from the social network including text data in a plurality of postings made on the social network service by the patient; and
identify the mental state of the patient with reference to an average sentiment identified in the text of the plurality of postings

24. The system method of claim 23, the processor being further configured to:
generate an alert message in response to identifying a deterioration in the mental state of the patient; and
send the alert message to an electronic device associated with a mental health professional who is treating the patient.
